(19) United States
(12) Patent Application Publication
(10) Pub. No.: US 2014/0316745 A1
(43) Pub. Date: Oct. 23, 2014

(54) DETECTING APPARATUS, DETECTING METHOD, AND COMPUTER PRODUCT

(71) Applicant: FUJITSU LIMITED, Kawasaki-shi (JP)

(72) Inventors: Takahisa SUZUKI, Yokohama (JP); Koichiro YAMASHITA, Hachioji (JP); Hiromasa YAMAUCHI, Usakos (JP); Yuta TERANISHI, Kawasaki (JP); Toshiya OTOMO, Kawasaki (JP)

(21) Appl. No.: 14/322,733

(22) Filed: Jul. 2, 2014

Related U.S. Application Data
(63) Continuation of application No. PCT/JP2012/050042, filed on Jan. 4, 2012.

(51) Int. Cl. G01D 11/00

(52) U.S. Cl. CPC G01D 11/00
USPC 702/189

(57) ABSTRACT

A detecting apparatus includes processors configured to access sensors; select from among the sensors, a sensor that has not been selected by any processor, acquire data from the selected sensor, and release selection of the sensor when data acquisition has been completed; execute processing for the sensor, based on the acquired data; set the sensor to an execution state during execution of the processing for the sensor, and set the sensor to an execution completed state when the execution of the processing for the sensor has ended; copy from a processor that has set the sensor to the execution state, the data acquired from the sensor by the processor, upon determining the sensor to be in the execution state, without executing the data acquisition; and execute the processing for the sensor, based on the copied data.

### CROSS REFERENCE TO RELATED APPLICATIONS

This application is a continuation application of International Application PCT/JP2012/050042, filed on Jan. 4, 2012 and designating the U.S., the entire contents of which are incorporated herein by reference.

### FIELD

The embodiments discussed herein are related to a detecting apparatus, a detecting method, and a computer product.

### BACKGROUND

Conventionally, for example, in systems in which processors compute data from sensors, a known technology confirms whether a processor has stopped consequent to two processors alternately writing different values to a check-dedicated area provided in shared memory (for example, refer to Japanese Laid-Open Patent Publication No. H2-206806). More specifically, among the two processors, one processor determines that the other processor has stopped if the value written by the one processor is not updated.

Further, for example, according to a known technology, each processor among a group of processors outputs operation information to shared memory and a main processor among the group detects a malfunctioning processor by monitoring the operation information output to the shared memory (for example, refer to Japanese Laid-Open Patent Publication No. H6-44102).

Nonetheless, whether a detected malfunctioning processor has processed the data of a sensor is unclear. Consequently, if a malfunctioning processor is present, a problem arises in that computation related to the sensor is not completed.

### SUMMARY

According to an aspect of an embodiment, a detecting apparatus includes processors configured to access sensors; select from among the sensors, a sensor that has not been selected by any processor, acquire data from the selected sensor, and release selection of the sensor when data acquisition has been completed; execute processing for the sensor, based on the acquired data; set the sensor to an execution state during execution of the processing for the sensor, and set the sensor to an execution completed state when the execution of the processing for the sensor has ended; copy from a processor that has set the sensor to the execution state, the data acquired from the sensor by the processor, upon determining the sensor to be in the execution state, without executing the data acquisition; and execute the processing for the sensor, based on the copied data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an operation example of a detecting apparatus according to an embodiment;

FIG. 2 is a block diagram depicting an example of a hardware configuration of a detecting apparatus 100;

FIG. 3 is a diagram depicting an example of data fields of local memory 102 and a sensor 103;

FIG. 4 is a diagram depicting an example of sensor state transitions indicated by processing state flags of sensors 103;

FIG. 5 is a block diagram depicting a functional example of the sensors 103;

FIG. 6 is a block diagram of a functional configuration of the detecting apparatus 100;

FIG. 7 is a diagram depicting an operation example of the detecting apparatus 100 when no CPU 101 is present at which failure has occurred;

FIG. 8 is a diagram depicting a first operation example of the detecting apparatus 100 when a CPU 101 is present at which a failure occurred;

FIG. 9 is a diagram depicting a second operation example of the detecting apparatus 100 when a CPU 101 is present at which a failure occurred;

FIG. 10 is a diagram depicting third operation example of the detecting apparatus 100 when a CPU 101 is present at which a failure has occurred;

FIG. 11 is a diagram depicting a fourth operation example of the detecting apparatus 100 when a CPU 101 is present at which a failure occurred;

FIGS. 12, 13, 14, 15, and 16 are flowcharts of a processing procedure performed by the CPUs 101 of the detecting apparatus 100; and

FIG. 17 is a flowchart of a processing procedure performed by the control unit 504 of the sensors 103.

### DESCRIPTION OF EMBODIMENTS

Embodiments of a detecting apparatus, a detecting method, and a computer product will be described in detail with reference to the accompanying drawings.

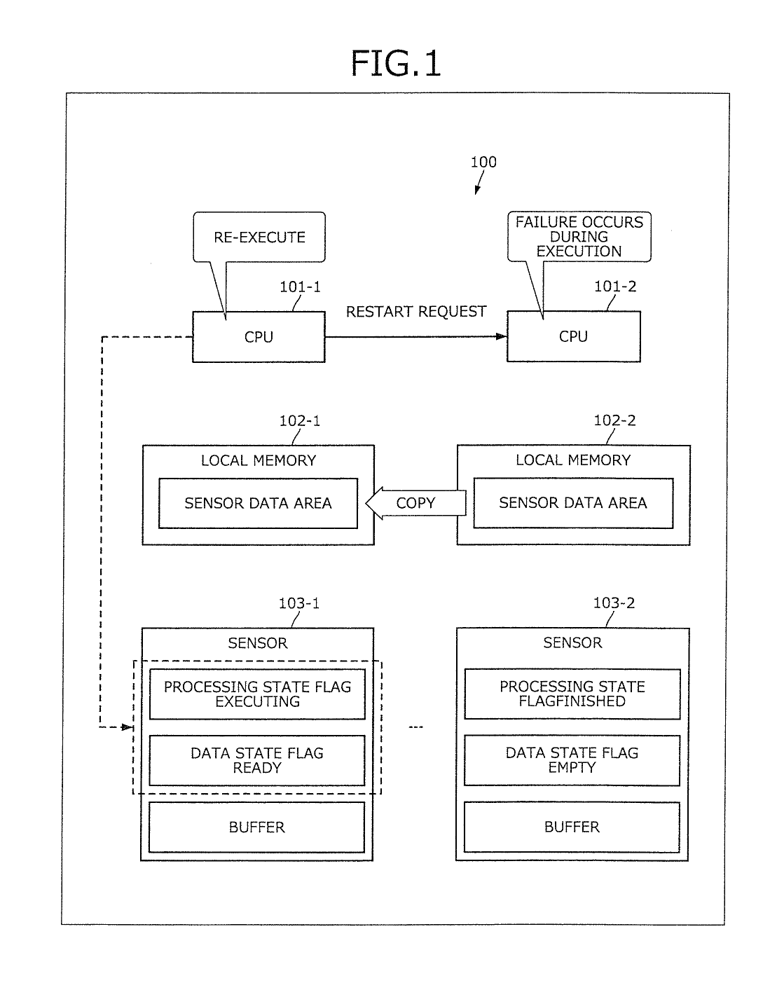

FIG. 1 is a diagram depicting an operation example of a detecting apparatus according to an embodiment. A detecting apparatus 100 has sensors 103 and central processing units (CPUs) 101. A detailed system hardware configuration will be described hereinafter. The CPUs 101 can access the CPUs 101. In FIG. 1, an example in the case of 2 CPUs 101 is depicted.

The CPUs 101 are highly reliable as elements for stable operation over long periods. Data obtained by the sensors 103 have various patterns and therefore, during processing for a sensor 103 performed by a CPU 101, the sensor 103 may generate unintended data. Further, data under analysis processing by the CPU 101 may become corrupt consequent to the effects of noise from an external device. In the worst case, the CPU 101 may hang up such as when analysis processing at the CPU 101 is in a recursive loop and does not end. To achieve high reliability, even when such unexpected data arises, processing for each sensor 103 has to be continued as far as possible and if continuation becomes difficult, the user has to be notified of such.

If the CPU 101 is disposed in plural for data processing, even if one of the CPUs 101 stops, the other CPUs 101 detect the stopping and can take over the processing continue the process. In the example depicted in FIG. 1, the CPU 101-2 fails while executing a process for a sensor 103; and the CPU 101-1 detects the failure and executes the process executed by the CPU 101-2.

Processing state flags of the sensors 103 indicate the states of the sensors 103. If the processing state flag of a sensor 103 is set to “EXECUTING”, the processing state flag indicates that the sensor is in an execution state. The execution state indicates that processing for the sensor 103 is under execution by a CPU 101. If the processing state flag of a sensor 103 is set to “FINISHED”, the processing state flag indicates that the sensor is in an execution completed state. The execution completed state indicates that no processing for the sensor 103 is under execution by a CPU 101.

A data state flag of a sensor 103 indicates whether one unitary processing amount of data obtained by the sensor 103 has accumulated in a buffer. There are data state flags indicating whether one unitary processing amount of data obtained by the sensors 103 has accumulated in a buffer. If the data state flag is set to “READY”, the data state flag indicates that one unitary processing amount of data has accumulated in the buffer. If the data state flag is set to “EMPTY”, the data state flag indicates that one unitary processing amount of data has not accumulated in the buffer or that a CPU 101 has acquired the accumulated data.

The period of the data process at the CPUs 101 differs according to the data detected by the sensor 103. Therefore, the designer of the detecting apparatus 100 has to design the detecting apparatus 100 such that the sequence of the data processes is not reversed. For example, the processing capacity of the CPUs 101, the number of CPUs 101, the intervals at which data is output by the sensors 103, etc. has to be adjusted such that the previous data process is completed within the period that a data state flag changes from “EMPTY” to “READY”. In other words, within the period that the data state flag of a given sensor 103 changes from “EMPTY” to “READY”, all CPUs 101 have to complete processing for the given sensor 103.

In FIG. 1, for example, the CPU 101-2 recursively checks and monitors the data state flags of the sensors 103, and selects a sensor 103-1, which has not been selected by a CPU 101. More specifically, upon discovering the sensor 103-1 for which the data state flag has become “READY”, the CPU 101-2 sets the data state flag of the sensor 103-1 to “TRANSFERRING” and thereby, selects the sensor 103-1.

The CPU 101-2 acquires from the sensor 103-1, the data obtained by the sensor 103-1; and after the data acquisition has ended, releases the selection. More specifically, the CPU 101-2 acquires the data from the buffer of the sensor 103-1. After the data acquisition has ended, the CPU 101-2 changes the data state flag from “TRANSFERRING” to “EMPTY” and thereby, releases the selection.

The CPU 101-2 executes processing for the sensor 103-1, based on the data acquired while the sensor 103-1 was selected. During execution of the process, the CPU 101-2 sets the sensor 103-1 to the execution state and when the execution has ended, sets the sensor 103-1 to the execution completed state. More specifically, the CPU 101-2 sets the processing state flag of the sensor 103-1 to “EXECUTING” and executes processing for the sensor 103-1, based on the acquired data. When the processing for the sensor 103-1 has been completed based on the acquired data, the CPU 101-2 sets the processing state flag of the sensor 103-1 to “FINISHED”.

The CPU 101-1 selects the sensor 103-1, which has not been selected by a CPU 101 and determines whether the selected sensor 103-1 is in the execution state. More specifically, in the example depicted in FIG. 1, the CPU 101-1 recursively checks and monitors the data state flag of the sensor 103-1 and upon discovering the sensor 103-1 for which the data state flag has become “READY”, determines whether information has been set for the processing state flag. In the example depicted in FIG. 1, the processing state flag is set to “EXECUTING” and therefore, the CPU 101-1 determines that the sensor 103-1 is in the execution state.

As described, irrespective of the CPU 101 having to complete processing for a given sensor 103 within the period that the data state flag of the given sensor 103 changes from “EMPTY” to “READY”, in this example, the CPU 101 has not finished. Therefore, the CPU 101 can determine that a failure has occurred at the CPU 101 previously executing the data. In the example depicted in FIG. 1, since two CPUs 101 are provided, the CPU 101-1 can discriminate a CPU 101 at which a failure has occurred. In the case of plural CPUs 101, for example, a CPU 101 may record in a sensor 103, identification information of the CPU 101 when executing processing for the sensor 103.

If the CPU 101-1 determines that the sensor 103-1 is in the execution state, without executing the data acquisition, the CPU 101-1 copies from the processor that set the sensor 103-1 to the execution state, the data that the CPU 101-2 acquired from the sensor 103-1. More specifically, if the processing state flag indicates “EXECUTING”, the CPU 101-1, without acquiring the data from the buffer of the sensor 103-1, copies the data stored in a data storage area of local memory 102-2 and stores the copied data to local memory 102-1.

The CPU 101-1 executes processing for the sensor 103-1, based on the copied data. The CPU 101-1 may cause the CPU 101-2 to restart by sending a restart request to the CPU 101-2.

The detecting apparatus 100 is a sensor box equipped with various types of sensors such as an imaging sensor, sound sensor, and temperature sensor. For example, in the medical field, the sensor box enables the physical condition of a patient to be monitored and a physician, family member, etc. to be notified when there is an abnormality. For example, the sensor box enables indoor conditions to be monitored and, a security company or the home owner to be notified when an intruder or fire is detected or automatic adjustment of the air conditioning and lighting.

Such a sensor box has been assumed to be stationary and of a large size and therefore, not portable and requiring construction work for installation. Recently, sensors 103 and wireless communication devices are smaller in size and consume less power, enabling reductions in the size of sensor boxes. As a result, for example, in the medical field, battery and solar battery operation enable portability of a sensor box when a patient goes outside and increased installation freedom where wiring is unnecessary when the sensor box is installed indoors.

Stable operation over long periods is demanded of such sensor boxes. Therefore, the power consumption of a sensor box has to be reduced to extend the operation period and enable operation by even the small amount of power generated by a solar battery. By the sensor box, the CPU 101 acquires and analyzes data obtained as needed by the various sensors 103, and detects abnormalities in temperature, suspicious objects, etc. recorded by a camera, etc. and notifies an external terminal of the abnormality, suspicious objects, etc. by wireless communication.

To reduce the power consumption of the sensor box, reductions in the power consumed for processing to analyze the data acquired by the CPU 101 are essential. On the other hand, for example, in the analysis of image data, high processing performance is necessary and when the sensor 103 of high sensitivity is provided in plural, the processing performance demanded for the analysis processing is high. Thus, as one method of achieving both high performance and low power consumption, CPUs specialized for data processing are provided in the sensor box, and the processing of data from the sensors 103 is performed by this data processing CPU group. If an abnormality of a data processing CPU is detected, a general purpose CPU is started and a process is performed that achieves versatility by performing notification by wireless communication.

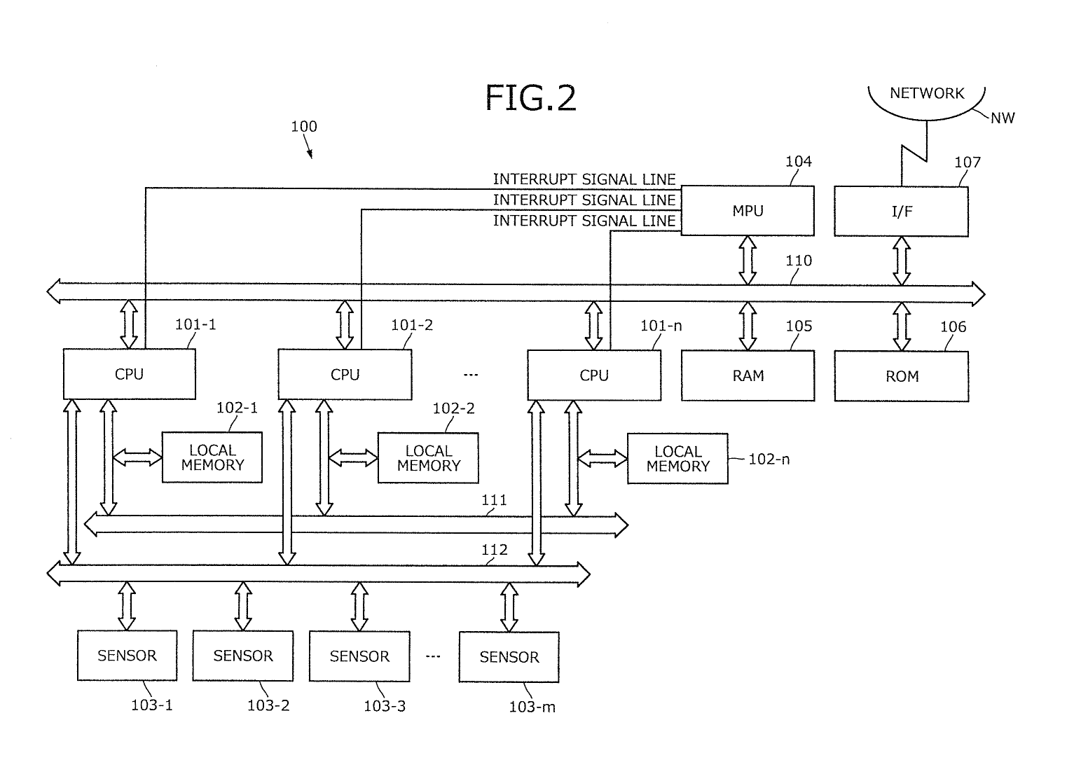

In the present embodiment, the detecting apparatus 100 splits processing between the CPUs 101 that execute processing for the sensors 103 and a micro-processing unit (MPU) that communicates with another apparatus. With reference to FIG. 2, a hardware configuration of the detecting apparatus 100 depicting a sensor box will be described in detail.

FIG. 2 is a block diagram depicting an example of a hardware configuration of the detecting apparatus 100. The detecting apparatus 100 includes the CPUs 101-1 to 101-n, the local memory 102-1 to 102-n, and the sensors 103-1 to 103-m. Further, a detecting system includes random access memory (RAM) 105, read-only memory (ROM) 106, an MPU 104, and an interface (I/F) 107.

The CPUs 101-1 to 101-n, the RAM 105, the ROM 106, the MPU 104, and the I/F 107 are respectively connected by a main bus 110. The CPUs 101-1 to 101-n and the local memory 102-1 to 102-n are respectively connected by a memory bus 111. The CPUs 101-1 to 101-n and the sensors 103-1 to 103-m are respectively connected by the sensor bus 112. The CPUs 101-1 to 101-n cause an interrupt at the MPU 104 by outputting an interrupt signal to an interrupt signal line.

Here, the MPU 104 governs overall control of the detecting apparatus 100. The ROM 106 stores programs such as a boot program and a driver of the sensors 103. The RAM 105 is used as a work area of the MPU 104.

The CPUs 101-1 to 101-n are respectively equipped with the local memory 102-1 to 102-n. The local memory 102-1 to 102-n is used as a work area by the CPUs 101-1 to 101-n, respectively. Although the CPUs 101 are configured to access the local memory 102 of other CPUs 101, the access speed to the local memory 102 thereof is faster than the access to the local memory 102 of another CPU 101.

The I/F 107 is connected, via a communication line, to a network NW such as a local area network (LAN), a wide area network (WAN) and the Internet, and is connected to other apparatuses through the network NW. The I/F 107 administers an internal interface with the network NW and controls the input and output of data with respect to an external apparatus. A modem, a LAN adapter, etc. may be adopted as the I/F 107, for example.

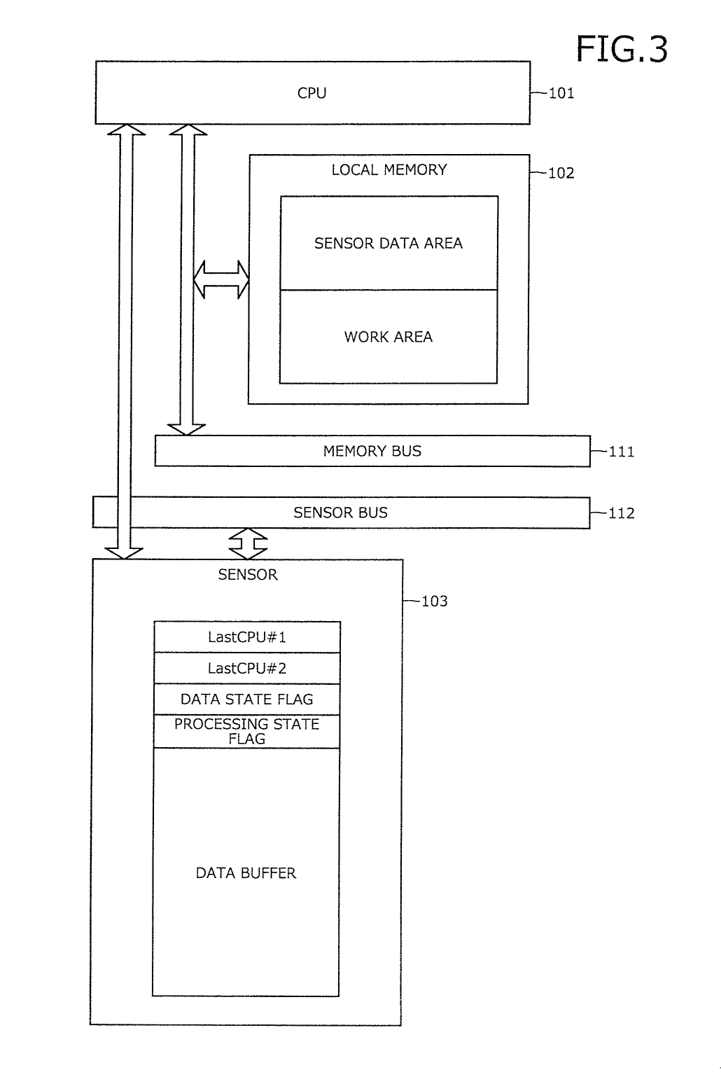

The local memory 102 of each CPU 101 and data fields concerning the sensors 103 will be described with reference to FIG. 3.

FIG. 3 is a diagram depicting an example of data fields of the local memory 102 and the sensor 103. The local memory 102 has a sensor data area and a work area. The sensor data area retains data detected by the sensor 103. The work area is an area where the CPU 101 executes processing for the sensor using the data stored in the sensor data area.

The storage area of the sensor 103 has fields for last CPU#1, last CPU#2, data state flag, processing state flag, and data buffer. In the last CPU#1 field, identification information of the CPU 101 that executes processing concerning updated data is registered. In the last CPU#2 field, identification information of the CPU 101 that executes processing concerning the previous data is registered. In the present embodiment, identification of the CPUs 101 is assumed to be numbers given to the CPUs 101 in FIG. 2. For example, the CPU 101-1 is registered in the last CPU#1 and the last CPU#2 fields as “CPU 101-1”, the identification information thereof.

In the data state flag field, a flag is set indicating whether sensor-obtained data is in an executable state by the CPU 101. In the data state flag field, “EMPTY”, “READY”, or “TRANSFERRING” is set. “EMPTY” indicates that the data is not in a processable state by the CPU 101. “READY” indicates that the data is in a processable state by the CPU 101. “TRANSFERRING” indicates that processable data is being accessed by a CPU 101.

The processing state flag field indicates the execution state of the CPU 101 for processing concerning data newly obtained by a sensor 103. In the data buffer field, the obtained data is sequentially registered. The sensor 103 updates the data state flag from “EMPTY” to “READY”, after a given volume of data or more accumulates in the data buffer field.

The processing state flag is set to “FINISHED”, “EXECUTING”, “RETRYING”, “RETRYING&EXECUTING”, or “RETRYING&FINISHED”.

“FINISHED” indicates that the sensor is in an execution completed state. The execution completed state indicates that processing concerning newly obtained data has been completed. “EXECUTING” indicates that the sensor is in the execution state. The execution state indicates that processing concerning the newly obtained data is under execution by a CPU 101. “RETRYING” indicates that the sensor is in a re-execution state. The re-execution state indicates that processing concerning the newly obtained data is under re-execution by a CPU 101. “RETRYING&EXCUTING” indicates that the sensor is in a re-execution and execution state. The re-execution and execution state indicates that processing concerning the newly obtained data is under execution by a CPU 101 and processing concerning data obtained before the newly obtained data is under re-execution by a CPU 101. “RETRYING&FINISHED” indicates that the sensor is in a re-execution and execution completed state. The re-execution and execution completed state indicates that processing concerning the newly obtained data has been completed and processing concerning data obtained before the newly obtained data is under re-execution by a CPU 101.

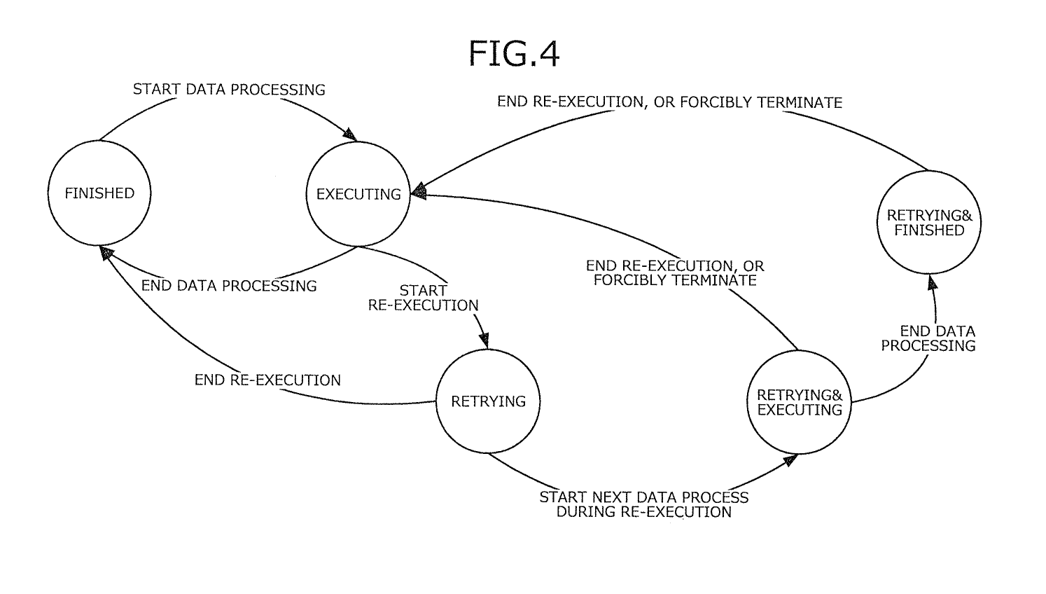

FIG. 4 is a diagram depicting an example of sensor state transitions indicated by the processing state flags of the sensors 103. The states depicted in FIG. 4 correspond to the information set in the processing state flag. When a processing state flag indicates “FINISHED”, the processing state flag is set to “EXECUTING” when processing concerning the data is started by at CPU 101.

When the processing state flag indicates “EXECUTING” and the processing concerning the data ends at the CPU 101, the processing state flag is set to “FINISHED”. When the processing state flag indicates “EXECUTING” and re-execution starts consequent to detection of a failure, the processing state flag is set to “RETRYING”.

When the processing state flag indicates “RETRYING” and the re-execution ends, the processing state flag is set to “FINISHED”. When the processing state flag indicates “RETRYING” and a process starts concerning a data group subsequent to that under execution, the processing state flag is set to “RETRYING&EXECUTING”.

When the processing state flag indicates “RETRYING&EXECUTING” and the re-executed process ends or is forcibly terminated, the processing state flag is set to “EXECUTING”. When the processing state flag is set to “RETRYING&EXECUTING” and a process of new data ends, the processing state flag is set to “RETRYING&FINISHED”.

When the processing state flag indicates “RETRYING&FINISHED” and re-execution ends or is forcibly terminated, the processing state flag is set to “EXECUTING”. In the present embodiment, the processing state flag is not changed from “RETRYING&FINISHED” to “FINISHED”. The processing state flag is set to “FINISHED”, after being changed from “RETRYING&FINISHED” to “EXECUTING”. Although described in detail hereinafter, the detecting apparatus 100 is thus able to observe the execution sequence of the data.

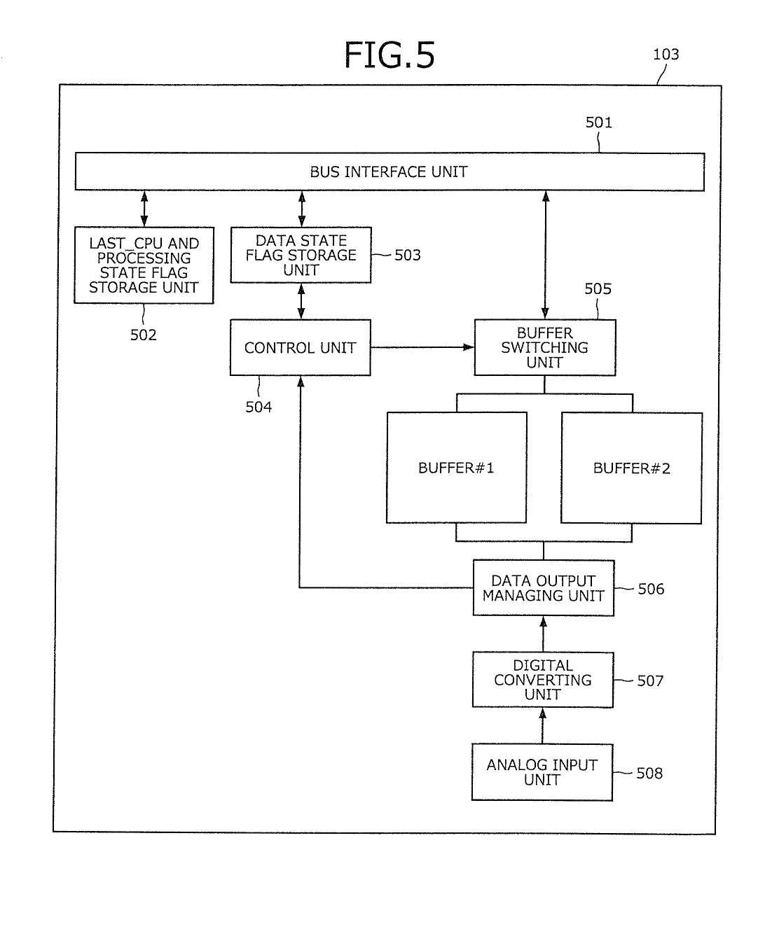

FIG. 5 is a block diagram depicting a functional example of the sensors 103. A functional example of the sensors 103 will be described in detail. The sensors 103 include a bus interface unit 501, a last_CPU and processing state flag storage unit 502, a data state flag storage unit 503, a control unit 504, a buffer switching unit 505, buffer #1, buffer #2, a data output managing unit 506, a digital converting unit 507, and an analog input unit 508.

The last_CPU and processing state flag storage unit 502 is a storage apparatus configured to store the last CPU#1, last CPU#2, and processing state flags. The RAM 105 may be given as an example of a storage apparatus. The data state flag storage unit 503 is a storage apparatus configured to store the data state flags. The RAM 105 may be given as an example of a storage apparatus. Buffer #1 and buffer #2 store data of one unitary processing amount.

The bus interface unit 501 controls the input of data from and the output of data to CPUs 101 connected via the sensor bus 112. According to a writing instruction from a CPU 101, the bus interface unit 501 sets data in the last CPU#1, last CPU#2, and processing state flags of the last_CPU and processing state flag storage unit 502. According to a writing instruction from a CPU 101, the bus interface unit 501 sets the data state flags of the data state flag storage unit 503.

The analog input unit 508 receives analog data obtained by the sensor 103 thereof. The analog input unit 508 transfers the received analog data to the digital converting unit 507.

The digital converting unit 507 coverts the analog data into digital data. The digital converting unit 507 outputs the digitally converted data to the data output managing unit 506. The data output managing unit 506 stores the data to buffer #1 to buffer #2 and manages whether one unitary processing amount of data is stored to buffer #1 or buffer #2.

The control unit 504 sets the data processing state to “EMPTY” at start up of the sensor 103 and sets the processing state flag to “FINISHED”. When one unitary processing amount data has accumulated in buffer #1 or buffer #2 and notification has been received from the data output managing unit 506, the control unit 504 changes the data storage flag of the data state flag storage unit 503 from “EMPTY” to “READY”. The control unit 504, upon detecting that the data process state changes from “TRANSFERRING” to “EMPTY”, instructs the buffer switching unit 505 to switch the buffer data output to the bus interface unit 501.

The buffer switching unit 505 switches the buffer data output to the bus interface unit 501, according to a buffer switching instruction from the control unit 504. For example, when newly obtained data of one unitary processing amount is stored in buffer #1, the buffer switching unit 505 switches from data output of buffer #2 to data output of buffer #1. On the other hand, for example, when newly obtained data of one unitary processing amount is stored in buffer #2, the buffer switching unit 505 switches from data output of buffer #1 to data output of buffer #2.

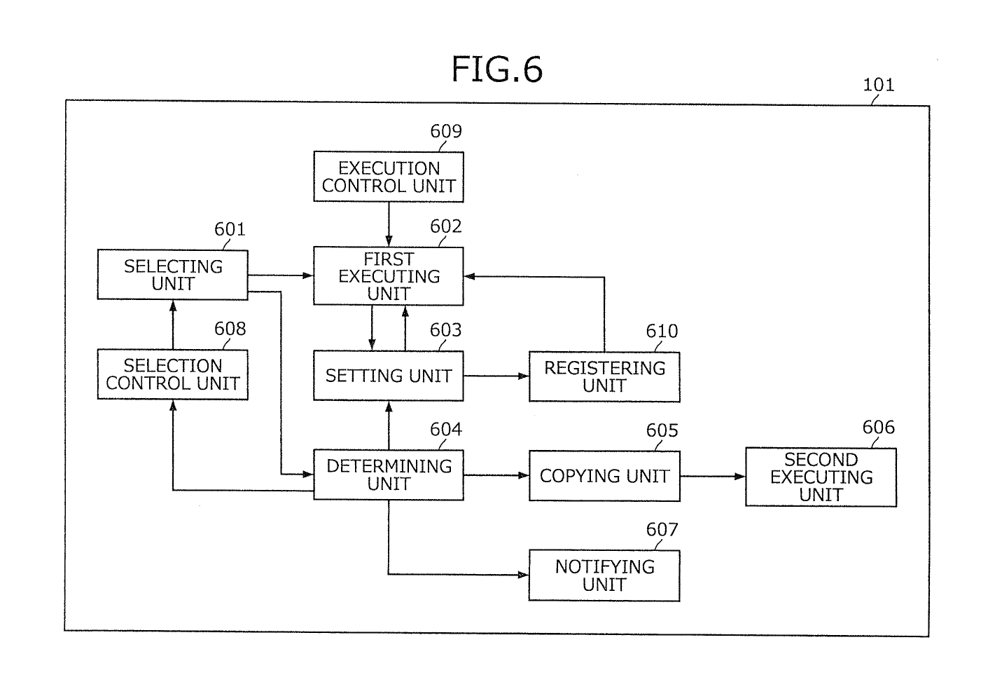

FIG. 6 is a block diagram of a functional configuration of the detecting apparatus 100. The CPUs 101 of the detecting apparatus 100 include a selecting unit 601, a first executing unit 602, a setting unit 603, a determining unit 604, a copying unit 605, a second executing unit 606, a notifying unit 607, a selection control unit 608, an execution control unit 609, and a registering unit 610. Processes from the selecting unit 601 to the notifying unit 607 are, for example, encoded in a search program stored in a storage apparatus such as the ROM 106, the RAM 105, etc. The CPUs 101 load programs from the storage apparatus and execute the processes encoded in the program, whereby functions of the selecting unit 601 to the notifying unit 607 are implemented.

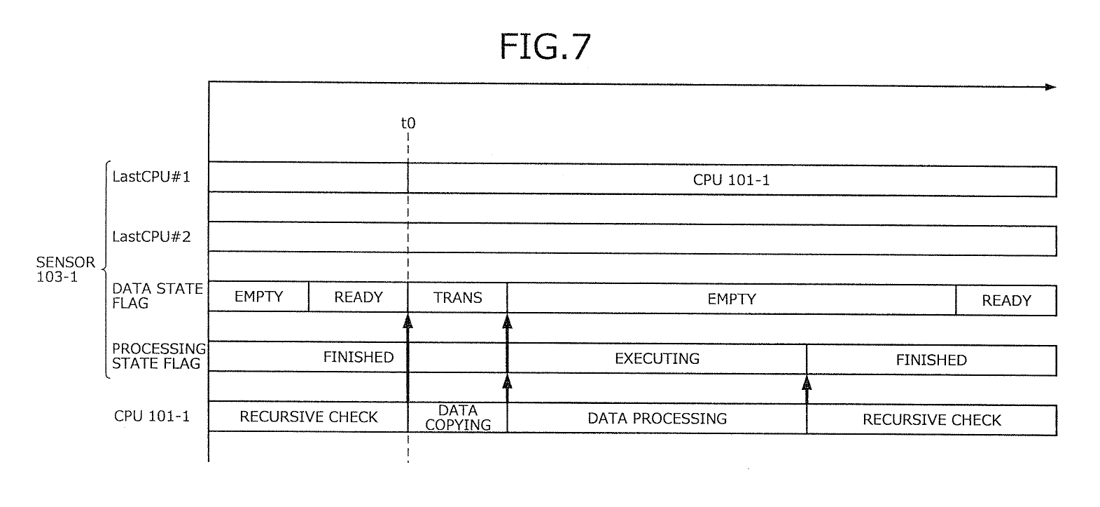

Process results of the functional units, for example, are stored to a work area of the local memory 102. Each function will be described in detail with reference to FIGS. 7 to 11. In the description hereinafter, a “−number” appended to a functional unit corresponds to the number given to the CPU 101 and indicates the CPU 101 to which the functional unit belongs.

FIG. 7 is a diagram depicting an operation example of the detecting apparatus 100 when no CPU 101 is present at which failure has occurred. In FIG. 7, the CPU 101-1 is taken as an example. The selecting unit 601-1 selects among the sensors 103, the sensor 103-1, which has not been selected by a CPU 101. The selecting unit 601-1 acquires data from the selected sensor 103-1. The selecting unit 601-1 releases the selection after completion of the data acquisition. The determining unit 604-1 determines whether the sensor 103-1 selected by the selecting unit 601-1 is in the execution state.

For example, the selecting unit 601-1 recursively checks the data state flag of the sensor 103-1. For example, the selecting unit 601-1 detects at time t0, the sensor 103-1 for which the data state flag changes to “READY”. As a result, the selecting unit 601-1 can detect among the sensors 103, the sensor 103-1 that has not been selected by any CPU 101. Further, the selecting unit 601-1 is assumed to not be able to select the sensor 103-1 for which the data state flag indicates “EMPTY”.

For example, the determining unit 604-1 determines whether the processing state flag of the sensor 103-1 detected by the selecting unit 601-1 is set to “EXECUTING”. As described, “EXECUTING” indicates that the sensor 103-1 is in the execution state. In this example, since the sensor 103-1 is set to “FINISHED”, the determining unit 604-1 determines that the sensor 103-1 is not in the execution state. Thus, the determining unit 604-1 determines that no CPU 101 is present at which a failure occurred during execution of processing for the sensor 103-1.

Subsequently, for example, the selecting unit 601-1 sets the data state flag to “TRANSFERRING”. The selecting unit 601-1, using a compare-and-swap (CAS) function, exclusively sets the data state flag to “TRANSFERRING”. Thus, the selecting unit 601-1 selects the sensor 103-1. For example, the selecting unit 601-1 acquires from buffer #0 or buffer #1 of the sensor 103-1, one unitary processing amount of data and stores the acquired data to the sensor data area of the local memory 102-1.

Subsequently, for example, after completion of the data acquisition, the selecting unit 601-1 sets the data state flag to “EMPTY”. Thus, the selecting unit 601-1 can release the selection of the sensor 103-1.

The first executing unit 602-1 executes processing for the sensor 103-1, based on the data acquired by the selecting unit 601-1 during the selection. The setting unit 603-1 sets the sensor 103-1 to the execution state during execution of the processing for the sensor 103-1 by the first executing unit 602-1 and sets the sensor 103-1 to the execution completed state when the execution of the processing for the sensor 103-1 is completed by the first executing unit 602-1.

For example, before the execution of the processing for the sensor 103-1 by the first executing unit 602-1, the setting unit 603-1 sets the processing state flag of the sensor 103-1 to “EXECUTING”, whereby the setting unit 603-1 can set the sensor 103-1 to the execution state. Further, for example, the registering unit 610-1 sets identification information of the CPU 101-1 in the last CPU#1 field.

Next, for Example, the first executing unit 602-1 loads the driver of the sensor 103-1 from the ROM 106. For example, the first executing unit 602-1 executes the driver of the sensor 103-1, based on data stored in a sensor data area of the local memory 102. Taking a temperature sensor as an example, the processing for the sensor 103-1 may be a determination of whether the temperature has exceeded a threshold, calculation of an average temperature, etc. For example, when the first executing unit 602-1 detects an abnormality during execution of the driver of the sensor 103-1, based on data, the first executing unit 602-1 notifies the MPU 104 of the abnormality by outputting an interrupt signal to an interrupt signal line. Taking a temperature sensor as an example, when the temperature exceeds the threshold, the first executing unit 602-1 may determine that an abnormality has occurred.

Next, for example, when the execution of processing for the sensor 103-1 has been completed by the first executing unit 602-1, the setting unit 603-1 sets the processing state flag of the sensor 103-1 to “FINISHED”. Thereby, the setting unit 603-1 can set the sensor 103-1 to the execution completed state.

An operation example of the detecting apparatus 100 when a CPU 101 is present at which a failure occurs during execution of processing for the sensor 103-1 will be described.

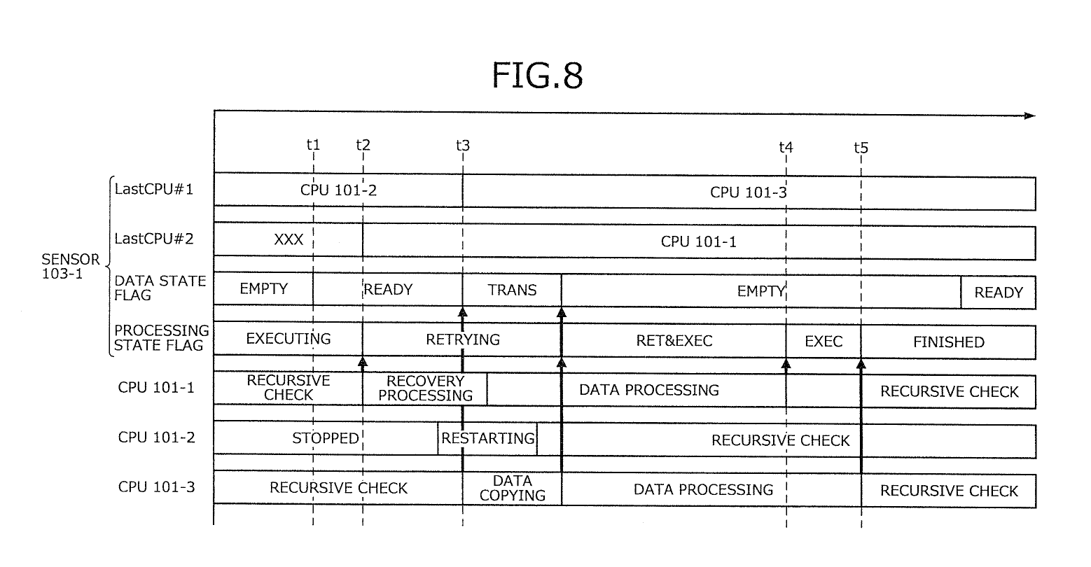

FIG. 8 is a diagram depicting a first operation example of the detecting apparatus 100 when a CPU 101 is present at which a failure occurred. As described, the determining unit 604-1 determines whether the processing state flag of the sensor 103-1 detected by the selecting unit 601-1 indicates “EXECUTING”. In the example depicted in FIG. 8, the processing state flag of the sensor 103-1 indicates “EXECUTING”. Consequently, the determining unit 604-1 determines that a CPU 101 is present at which a failure occurred during execution of processing for the sensor 103-1.

The detecting apparatus 100 has been designed by the designer to complete processing for the sensor 103-1, based on given data and within the period that one unitary processing amount of data is accumulated by the sensor 103-1 in a buffer in the sensor 103-1. If the data state flag changes from “READY” to “EMPTY”, i.e., irrespective of the next data having accumulated in the data in the sensor 103-1, the processing state flag of the sensor 103-1 is not usually “EXECUTING”. Therefore, here, the determining unit 604-1 determines that a failure has occurred at the CPU 101 that based on the given data, executed the processing for the sensor 103-1.

If the sensor 103-1 is determined to be in the execution state by the determining unit 604-1, the selection control unit 608-1 releases the selection without causing the selecting unit 601-1 to acquire data. More specifically, for example, if the processing state flag of the sensor 103-1 is determined to be “EXECUTING” by the determining unit 604-1, the selection control unit 608-1 does not cause the data state flag to be set to “TRANSFERRING” by the selecting unit 601-1. As a result, the selecting unit 601-1 does not select the sensor 103-1.

Subsequently, when the sensor 103-1 is determined to be in the execution state by the determining unit 604-1, the copying unit 605-1 does not execute the data acquisition by the selecting unit 601-1. The copying unit 605-1 copies from the CPU 101-2 that set the sensor 103-1 to the execution state, the data acquired from the sensor 103-1 by the CPU 101-2. The setting unit 603-1 sets the sensor 103-1 to the re-execution state while the second executing unit 606-1 is executing the processing for the sensor 103-1, and sets the sensor 103-1 to the execution completed state when the second executing unit 606-1 finishes executing the processing for the sensor 103-1.

More specifically, for example, the second executing unit 606-1 acquires the identification information registered in the last CPU#1 field. Subsequently, for example, the setting unit 603-1 sets the processing state flag of the sensor 103-1 to “RETRYING”. The setting unit 603-1, using a CAS function, may exclusively set the processing state flag of the sensor 103-1 to “RETRYING”. Next, for example, the copying unit 605-1 copies to a sensor data area of the local memory 102-1, data stored in a sensor data area of the local memory 102-2 of the CPU 101-2 identified by the identification information acquired by the setting unit 603-1.

The notifying unit 607-1 sends a restart request to the CPU 101-2 that set the sensor 103-1 to the execution state. The second executing unit 606-1 executes the processing for the sensor 103-1, based on the data copied by the copying unit 605-1. More specifically, for example, the notifying unit 607-1 sends the restart request to the CPU 101-2 identified by the acquired identification information. As a result, the CPU 101-2 restarts. For example, after the setting unit 603-1 sets the processing state flag of the sensor 103-1 to “RETRYING”, the second executing unit 606-1 executes processing for the sensor 103-1, based on the data copied by the copying unit 605-1.

Next, for example, at time t3, the selecting unit 601-3 detects the sensor 103-1 for which the data state flag indicates “READY”. For example, the determining unit 604-3 determines whether the processing state flag of the sensor 103-1 detected by the selecting unit 601-3 is set to “EXECUTING”. In this example, since the processing state flag is set to “RETRYING”, the determining unit 604-3 determines that the sensor 103-1 is not in the execution state.

Further, the determining unit 604-3 determines whether the sensor 103-1 is in the re-execution state. More specifically, for example, the determining unit 604-3 determines whether the processing state flag of the sensor 103-4 detected by the selecting unit 601-3 is set to “RETRYING”. In this example, since the processing state flag is set to “RETRYING”, the determining unit 604-3 determines that the sensor 103-1 is in the re-execution state. Thus, the determining unit 604-3 determines that recovery processing is being executed at a CPU 101, for the CPU 101-2 at which a failure occurred during execution of the processing for the sensor 103-1.

Next, for example, since the processing state flag indicates “RETRYING”, the selecting unit 601-3 sets the data state flag to “TRANSFERRING”. The selecting unit 601-3, using a CAS function, may exclusively set the data state flag of the sensor 103-1 to “TRANSFERRING”. Further, for example, the selecting unit 601-3 acquires from buffer #0 or buffer #1 of the sensor 103-1, one unitary processing amount of data. For example, the selecting unit 601-3 stores the acquired data to a sensor data area of the local memory 102. Further, for example, after completion of the data acquisition, the selecting unit 601-3 sets the data state flag to “EMPTY”. Thus, the selecting unit 601-3 can release the selection of the sensor 103-1.

If the sensor 103-1 is determined to be in the re-execution state by the determining unit 604-3, the setting unit 603-3 sets the sensor 103-1 to the re-execution and execution state. More specifically, for example, since the processing state flag indicates “RETRYING”, the setting unit 603-3 sets the processing state flag of the sensor 103-1 to “RETRYING&EXECUTING”, before the first executing unit 602-3 starts executing the processing for the sensor 103-1. Further, for example, the registering unit 610-3 registers the identification information of the CPU 101-3 as the last CPU#1 of the sensor 103-1.

Further, for example, the first executing unit 602-3 loads the driver of the sensor 103-1 from the ROM 106 and based on the data stored in the sensor data area of the local memory 102, executes the driver of the sensor 103-1.

Next, when the second executing unit 606-1 finishes executing the processing for the sensor 103-1, the determining unit 604-1 determines whether the sensor 103-1 is in the re-execution and execution state. If the determining unit 604-1 determines that the sensor 103-1 is in the re-execution and execution state, the setting unit 603-1 sets the sensor 103-1 to the execution state.

More specifically, for example, when the second executing unit 606-1 finishes executing the processing for the sensor 103-1 at time t4, the determining unit 604-1 determines whether the processing state flag of the sensor 103-1 indicates “RETRYING&EXECUTING”. In this example, the processing state flag of the sensor 103-1 is set to “RETRYING&EXECUTING”. Therefore, for example, when the processing state flag of the sensor 103-1 is determined to indicate “RETRYING&EXECUTING”, the setting unit 603-1 sets the processing state flag of the sensor 103-1 to “EXECUTING”.

When the first executing unit 602-3 finishes executing the processing for the sensor 103-1, the determining unit 604-3 determines the state of the sensor 103-1. More specifically, for example, when the first executing unit 602-3 finishes executing the processing for the sensor 103-1 at time t5, the determining unit 604-3 acquires the processing state flag of the sensor 103-1. For example, the determining unit 604-3 determines the information set in the processing state flag of the sensor 103-1. In this example, the processing state flag of the sensor 103-1 is set to “EXECUTING”.

If the determining unit 604-3 determines that the sensor 103-1 is in the execution state, the setting unit 603-3 sets the sensor 103-1 to the execution completed state. More specifically, for example, if the determining unit 604-3 determines that processing state flag of the sensor 103-1 is set to “EXECUTING”, the setting unit 603-3 sets the processing state flag of the sensor 103-1 to “FINISHED”.

Thus, the detecting apparatus 100 can cause processing executed at a CPU at which a failure occurred to be re-executed by another CPU.

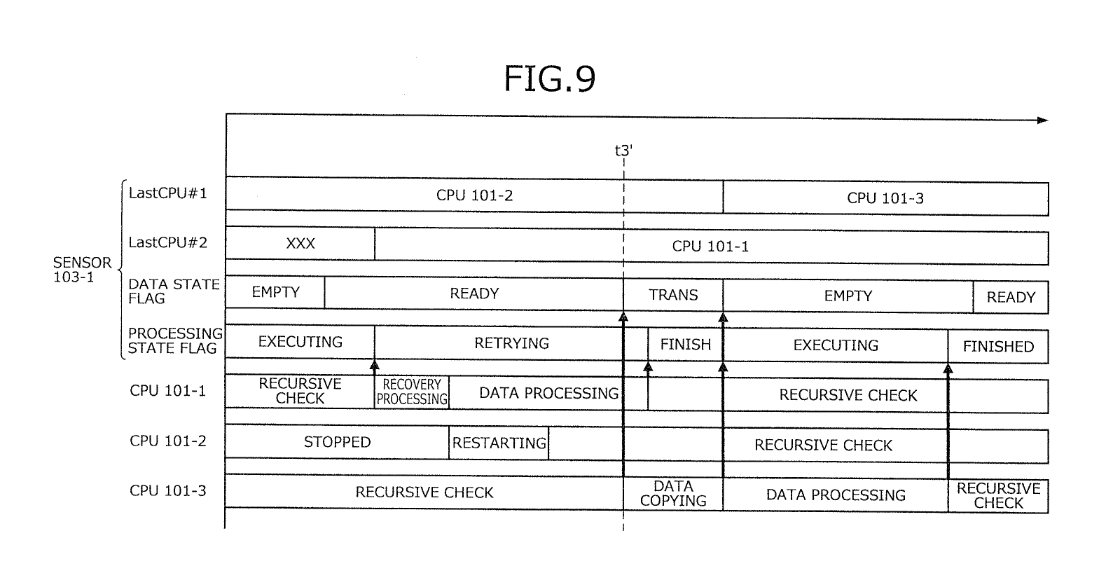

FIG. 9 is a diagram depicting a second operation example of the detecting apparatus 100 when a CPU 101 is present at which a failure occurred. When the CPU 101-3 starts acquiring data from the sensor 103-1 while the CPU 101-1 is performing re-execution, the CPU 101-3 may end data acquisition from the sensor 103-1 after and the CPU 101-1 has ended the re-execution. Thus, the CPU 101-3 determines the state of the sensor 103-1 after ending a process of acquiring data from the sensor 103-1; and according to the state, the CPU 101-3 determines which state to set the sensor 103-1.

For example, at time t3′, the selecting unit 601-3 sets the data state flag to “TRANSFERRING” and thereby, executes an exclusive process. For example, the selecting unit 601-3 acquires data from the sensor 103-1. For example, while the selecting unit 601-3 is acquiring data, the setting unit 603-1 changes the processing state flag of the sensor 103-1 from “RETRYING” to “FINISHED” when execution by the second executing unit 606-1 ends.

Next, for example, when the selecting unit 601-3 finishes acquiring data, the determining unit 604-3 acquires the processing state flag of the sensor 103-1 and determines the information that is set in the processing state flag. In this example, “FINISHED” is set. Therefore, the setting unit 603-3 sets the processing state flag of the sensor 103-1 to “EXECUTING” and the first executing unit 602-3 executes the processing for the sensor 103-1, based on the data acquired by the selecting unit 601-3.

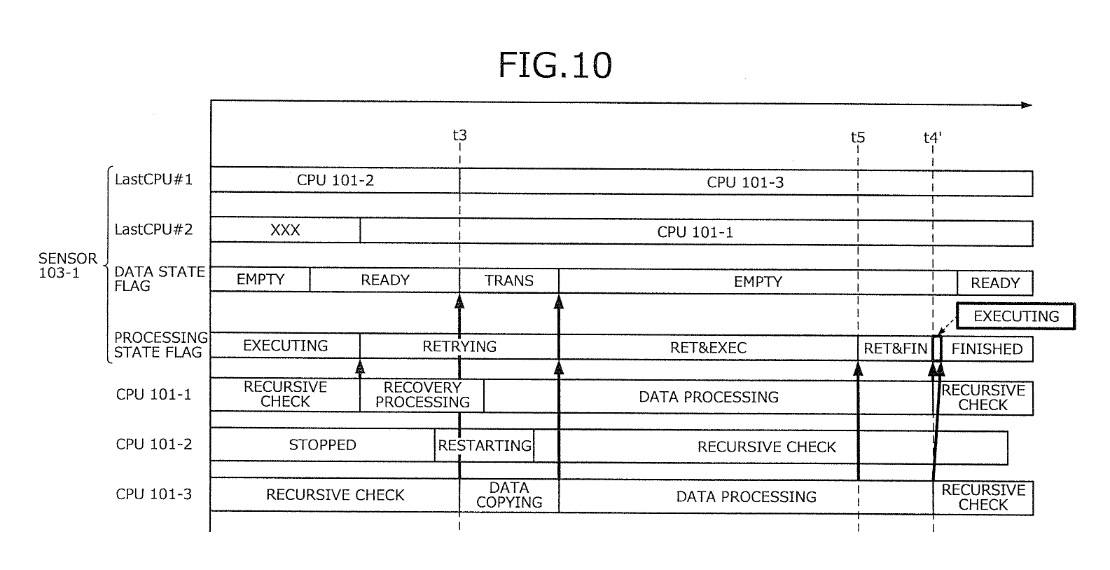

FIG. 10 is a diagram depicting third operation example of the detecting apparatus 100 when a CPU 101 is present at which a failure has occurred. If the CPU 101-3 finishes executing, based on new data, the processing for the sensor 103-1 before the CPU 101-1 finishes re-executing the processing that was executed at the CPU 101-2 at which a failure occurred, the execution sequence changes. Thus, in FIG. 10, the CPU 101-3 waits for the completion of the processing at the CPU 101-1 and then ends the processing. Up to time t5, details are identical to those depicted in FIG. 8; therefore, detailed description up to time t5 is omitted in the description of FIG. 10.

If the first executing unit 602-3 obtains execution results for the processing for the sensor 103-1, the determining unit 604-3 determines whether the sensor 103-1 is in the re-execution and execution state. If the determining unit 604-3 determines that the sensor 103-1 is in the re-execution and execution state, the execution control unit 609-3 does not terminate the execution by the second executing unit 606-3. If the determining unit 604-3 determines that the sensor 103-1 is in the re-execution and execution state, the setting unit 603-3 sets the sensor 103-1 to the re-execution and execution completed state.

More specifically, for example, if the first executing unit 602-3 obtains execution results for the processing for the sensor 103-1, the determining unit 604-3 acquires the processing state flag of the sensor 103-1. For example, the determining unit 604-3 determines whether the processing state flag of the sensor 103-1 indicates “RETRYING&EXECUTING”. In this example, the processing state flag of the sensor 103-1 indicates “RETRYING&EXECUTING” and therefore, the determining unit 604-3 can determine that execution has not finished, even without inquiring with the CPU 101 that is re-executing the processing that was executed by the CPU 101-2 at which a failure occurred, whether the execution has finished.

The setting unit 603-3, by the determining unit 604-3, sets the processing state flag of the sensor 103-1 to “RETRYING&FINISHED”. In FIG. 10, “RETRYING&FINISHED”, is abbreviated as “RET&FIN”. If the processing state flag of the sensor 103-1 is determined to be “RETRYING&EXECUTING”, the execution control unit 609-3 causes the driver of the sensor 103-1 to wait in an execution state, by the determining unit 604-3.

When the second executing unit 606-1 finishes executing the processing for the sensor 103-1, the determining unit 604-1 determines whether the sensor 103-1 is in the re-execution and execution completed state. If the determining unit 604-1 determines that the sensor 103-1 is in the re-execution and execution completed state, the setting unit 603-1 sets the sensor 103-1 to the execution state.

More specifically, for example, when the second executing unit 606-1 finishes executing the processing for the sensor 103-1, the determining unit 604-1 acquires the processing state flag of the sensor 103-1. Further, for example, the determining unit 604-1 determines whether the processing state flag of the sensor 103-1 indicates “RETRYING&FINISHED”. In this example, at time t4′, the processing state flag indicates “RETRYING&FINISHED”. For example, if the processing state flag of the sensor 103-1 is determined to be “RETRYING&FINISHED”, the setting unit 603-1 sets the processing state flag of the sensor 103-1 to “EXECUTING”.

The determining unit 604-3 determines whether the sensor 103-1 has changed from the re-execution and execution completed state to the execution state, after the setting unit 603-3 sets the sensor 103-1 to the re-execution and execution completed state. If the determining unit 604-3 determines that the sensor 103-1 has changed from the re-execution and execution completed state to the execution state, the execution control unit 609-3 causes the first executing unit 602 to end the execution of the processing for the sensor 103-1. When the first executing unit 602-3 has ended the processing for the sensor 103-1 and the determining unit 604-3 determines that the sensor 103-1 is in the execution state, the setting unit 603-3 sets the sensor 103-1 to execution completed state.

At time t4′ depicted in FIG. 10, the setting unit 603-1 has changed the processing state flag of the sensor 103-1 from “RETRYING&FINISHED” to “EXECUTING”. Therefore, the determining unit 604-3 determines that the processing state flag of the sensor 103-1 has changed from “RETRYING&FINISHED” to “EXECUTING”. For example, if the determining unit 604-3 determines that the processing state flag of the sensor 103-1 has changed from “RETRYING&FINISHED” to “EXECUTING”, the execution control unit 609-3 causes the driver of the sensor 103-1 to be terminated. When the first executing unit 602-3 has finished executing the processing for the sensor 103-1, the setting unit 603-3 sets the processing state flag of the sensor 103-1 to “FINISHED”.

Thus, the detecting apparatus 100 can execute the processing for the sensor 103-1 while observing the sequence in which the data was obtained, thereby enabling continuous execution of the processing for the sensor 103-1, based on the data obtained by the sensor 103-1.

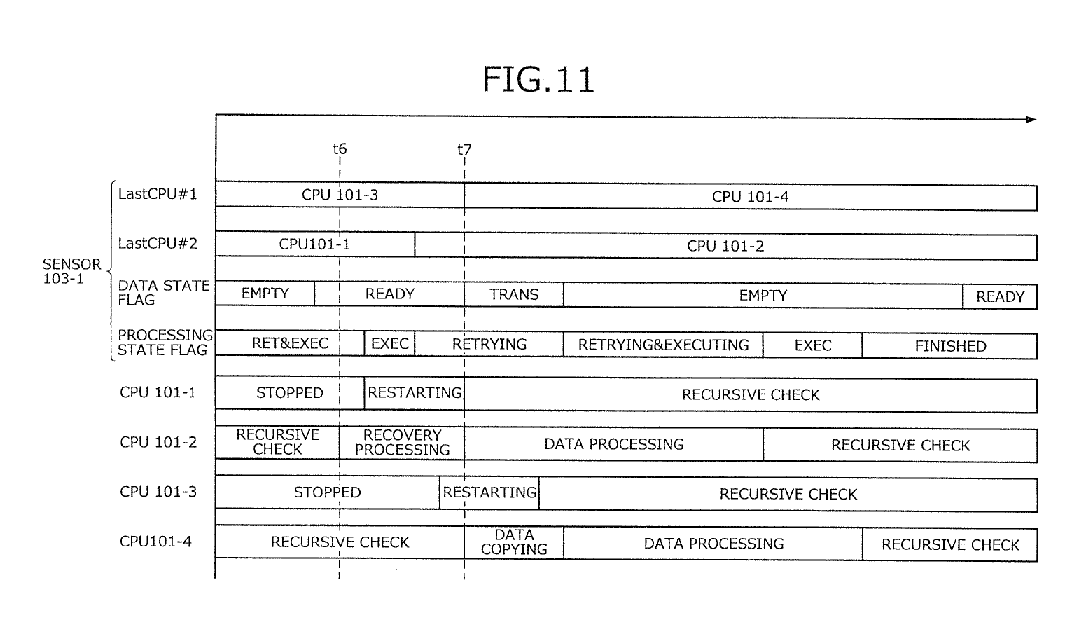

FIG. 11 is a diagram depicting a fourth operation example of the detecting apparatus 100 when a CPU 101 is present at which a failure occurred. In FIG. 11, if a failure occurs at the CPU 101-1 performing re-execution, the detecting apparatus 100 determines that the data is corrupt and terminates the processing for the sensor 103-1 and executed based on the data. In FIG. 11, the selecting unit 601-2 detects that the data state flag indicates “READY” at time t6.

The determining unit 604-2 determines whether the sensor 103-1, which has been selected by the selecting unit 601-2, is in the re-execution and execution state. More specifically, for example, if the data state flag of the sensor 103-1 indicates “READY”, the determining unit 604-2 acquires the processing state flag of the sensor 103-1. For example, the determining unit 604-2 determines whether the processing state flag of the sensor 103-1 indicates “RETRYING&EXECUTING”. In this example, the processing state flag of the sensor 103-1 indicates “RETRYING&EXECUTING”.

As described, within the period that the data state flag changes from “EMPTY” to “READY”, the CPUs 101 finish executing the processing for the sensor 103-1, based on the data acquired from the sensor 103-1. If the processing state flag of the sensor 103-1 indicates “RETRYING&EXECUTING” irrespective of the data state flag indicating “READY”, a failure may have occurred at both the CPU 101-1 and the CPU 101-3 executing the processing.

Therefore, before the state of the sensor 103-1 is set, the notifying unit 607-2 sends a restart request to the CPU 101 that set the state of the sensor 103-1 to “RETRYING&EXECUTING”. More specifically, for example, the notifying unit 607-2 acquires the identification information registered in the last CPU#2 field. The notifying unit 607-2 sends the restart request to the CPU 101-1 identified by the acquired identification information, whereby the CPU 101-1 performs re-execution.

If the sensor 103-1 is in the re-execution and execution state, the setting unit 603-2 sets the sensor 103-1 to the execution state. If the state of the sensor 103-1 has been set by the setting unit 603-2, the registering unit 610-2 registers the identification information of the CPU 101-2 into a second storage area of the sensor 103-1. Subsequently, the CPU 101-2 performs processing identical to the processing of the CPU 101-3 depicted in FIG. 8; and the CPU 101-4 executes the processing for the sensor 103-1, based on data newly obtained by the sensor 103-1.

Thus, if CPU failures successively occur consequent to processing for a sensor based on given data, the detecting apparatus 100 determines that the given data is corrupt and terminates the execution of the processing based on the given data. Therefore, the detecting apparatus 100 can cause processing for a sensor to be executed on continuous basis based on data obtained by the sensor.

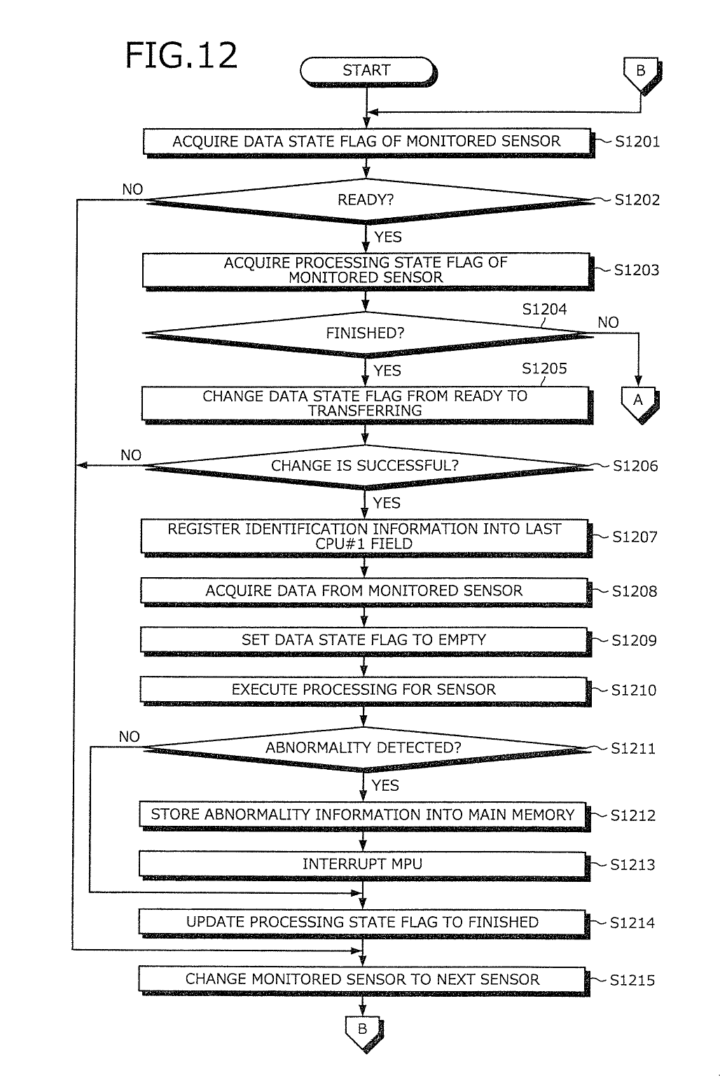

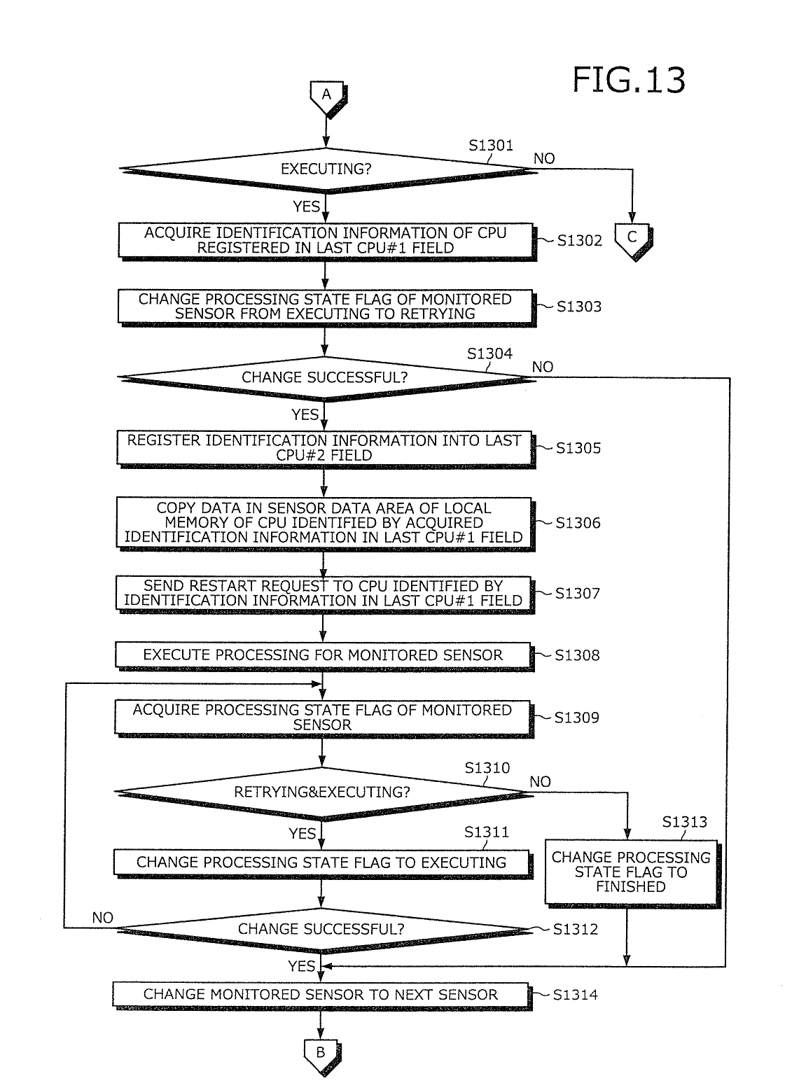

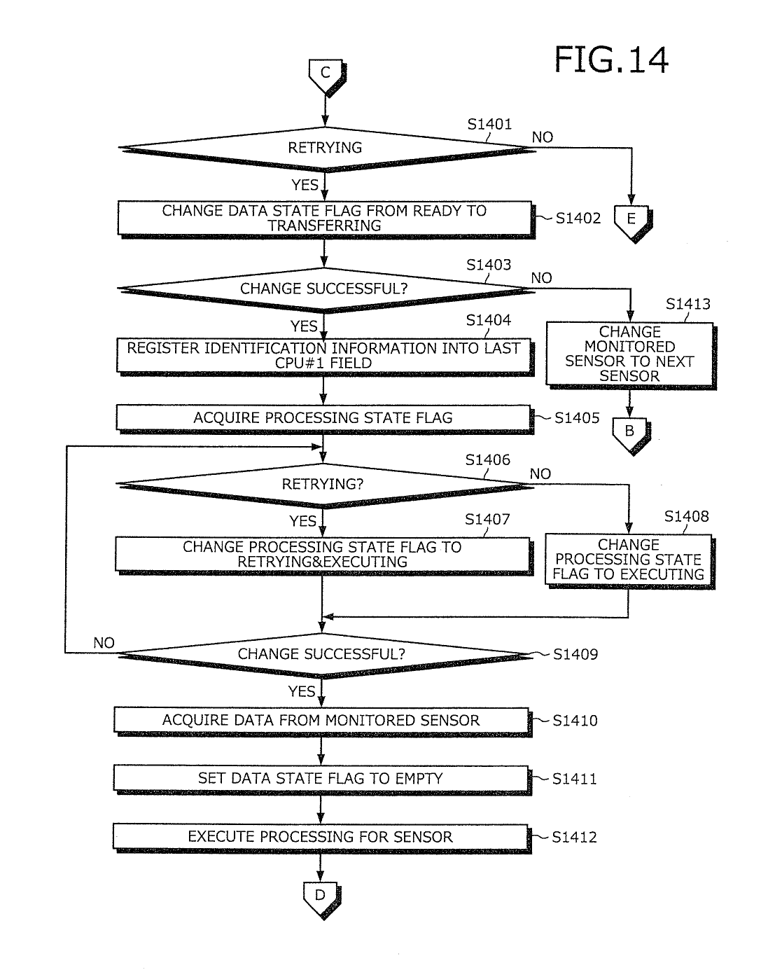

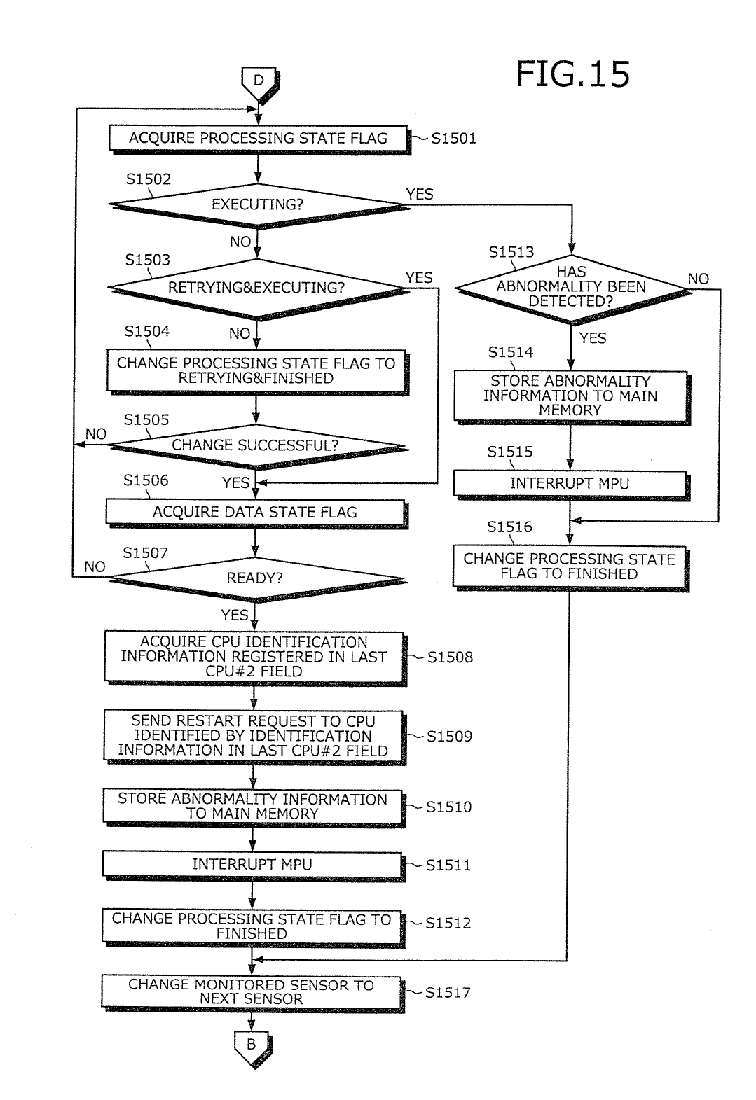

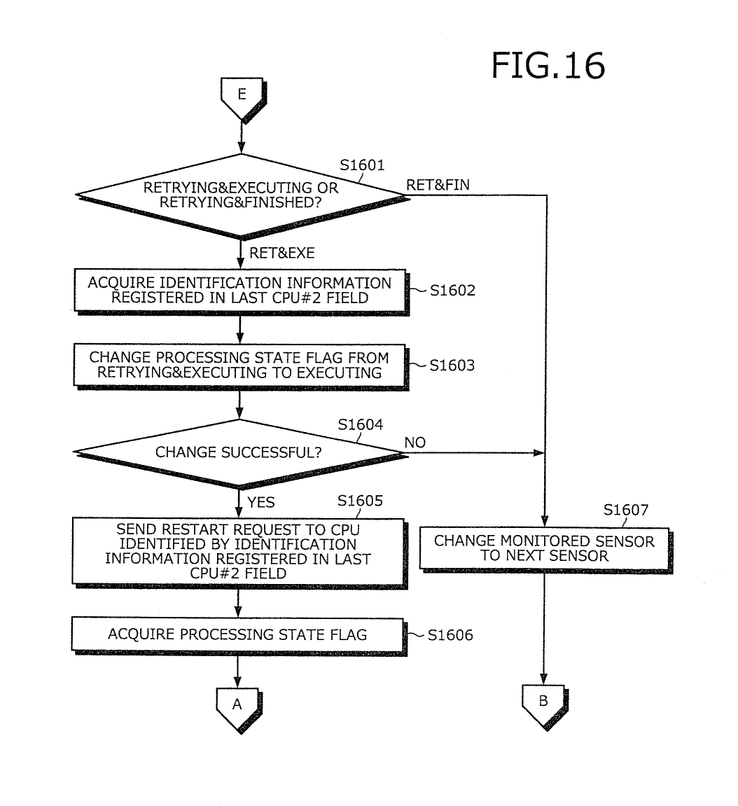

FIGS. 12, 13, 14, 15, and 16 are flowcharts of a processing procedure performed by the CPUs 101 of the detecting apparatus 100. Here, for example, the CPUs 101 monitor the sensors 103 in order of the identification information of the sensors 103. A CPU 101 acquires the data state flag of the monitored sensor (step S1201) and determines whether the data state flag indicates “READY” (step S1202). If the data state flag does not indicate “READY” (step S1202: NO), the CPU 101 switches the monitored sensor to the next sensor 103 (step S1215), and returns to step S1201.

On the other hand, if the data state flag indicates “READY” (step S1202: YES), the CPU 101 acquires the processing state flag of the monitored sensor (step S1203) and determines whether the processing state flag indicates “FINISHED” (step S1204). If the processing state flag indicates “FINISHED” (step S1204: YES), the CPU 101 changes the data state flag from “READY” to “TRANSFERRING” (step S1205). Thus, the CPU 101 performs exclusive control processing by setting the data state flag to “TRANSFERRING”.

Next, the CPU 101 determines whether the change is successful (step S1206). If the change has failed (step S1206: NO), the CPU 101 transitions to step S1215.

On the other hand, if the change is successful (step S1206: YES), the CPU 101 registers identification information into the last CPU#1 field (step S1207). The CPU 101 acquires data from the monitored sensor and stores the data to the sensor data area of the local memory 102 (step S1208). Next, the CPU 101 sets the data state flag to “EMPTY” (step S1209).

The CPU 101 sets the processing state flag to “EXECUTING”, and executes the processing for the sensor 103, based on the acquired data (step S1210). The CPU 101 determines whether an abnormality has been detected during execution (step S1211). If no abnormality has been detected (step S1211: NO), the CPU 101 transitions to step S1214. If an abnormality has been detected (step S1211: YES), the CPU 101 stores abnormality information into the main memory (step S1212). The CPU 101 interrupts the MPU 104 (step S1213). Upon receiving the interrupt signal from the CPU 101, the MPU 104 may notify other terminals via the I/F 107. Further, if the detecting apparatus 100 has an output apparatus such as a display, the MPU 104 may output to the output apparatus, indication of the abnormality. Subsequent to step S1213, the CPU 101 changes the processing state flag to “FINISHED” (step S1214), and transitions to step S1215.

Meanwhile, at step S1204, if the processing state flag does not indicate “FINISHED” (step S1204: NO), the CPU 101 transitions to step S1301. An example of the operations at steps S1201 to S1215 above is depicted in FIG. 7.

In the case of “NO” at step S1204 or subsequent to the operation at step S1606 described hereinafter, the CPU 101 determines whether the processing state flag of the monitored sensor indicates “EXECUTING” (step S1301). If the processing state flag of the monitored sensor indicates “EXECUTING” (step S1301: YES), the CPU 101 acquires the identification information of the CPU 101 registered in the last CPU#1 field (step S1302). The CPU 101 changes the processing state flag of the monitored sensor from “EXECUTING” to “RETRYING” (step S1303).

Next, the CPU 101 determines whether the change is successful (step S1304). If the change has failed (step S1304: NO), the CPU 101 transitions to step S1314. If the change is successful (step S1304: YES), the CPU 101 registers identification information into the last CPU#2 field of the monitored sensor (step S1305). The CPU 101 copies to the sensor data area of the local memory 102, the data in the sensor data area of the local memory 102 of the CPU 101 identified by the acquired identification information in the last CPU#1 field (step S1306). The CPU 101 sends a restart request to the CPU 101 identified by the acquired identification information in the last CPU#1 field (step S1307). Thus, the CPU 101 identified by the identification information of the last CPU#1 field is restarted.

Next, the CPU 101 executes processing for the monitored sensor, based on the copied data (step S1308). Here, although a case where an abnormality is detected during execution is omitted, the CPU 101 performs operations identical to those described at steps S1211 to S1213. The CPU 101 acquires the processing state flag of the monitored sensor (step S1309), and determines whether the processing state flag of the monitored sensor indicates “RETRYING&EXECUTING” (step S1310).

If the processing state flag of the monitored sensor indicates “RETRYING&EXECUTING” (step S1310: YES), the CPU 101 changes the processing state flag of the monitored sensor to “EXECUTING” (step S1311) and determines whether the change is successful (step S1312).

If the change is successful (step S1312: YES), the CPU 101 transitions to step S1314. On the other hand, if the change has failed (step S1312: NO), the CPU 101 returns to step S1309.

At step S1310, if the processing state flag of the monitored sensor does not indicate “RETRYING&EXECUTING” (step S1310: NO), the CPU 101 changes the processing state flag of the monitored sensor to “FINISHED” (step S1313).

In the case of “YES” at step S1312, “NO” at step S1304, or subsequent to the operation at step S1313, the CPU 101 changes the monitored sensor to the next sensor 103 (step S1314), and returns to step S1201.

If the processing state flag of the monitored sensor does not indicate “EXECUTING” (step S1301: NO), the CPU 101 transitions to step S1401. An example of the operations at steps S1301 to S1314 described above is depicted in FIG. 8.

After “NO” at step S1301, the CPU 101 determines whether the processing state flag of the monitored sensor indicates “RETRYING” (step S1401). If the processing state flag of the monitored sensor indicates “RETRYING” (step S1401: YES), the CPU 101 changes the data state flag of the monitored sensor from “READY” to “TRANSFERRING” (step S1402) and determines whether the change is successful (step S1403).

If the change is successful (step S1403: YES), the CPU 101 registers identification information into the last CPU#1 field (step S1404) and acquires the processing state flag of the monitored sensor (step S1405). The CPU 101 determines whether the acquired processing state flag indicates “RETRYING” (step S1406). If the processing state flag indicates “RETRYING” (step S1406: YES), the CPU 101 changes the processing state flag of the monitored sensor to “RETRYING&EXECUTING” (step S1407) and transitions to step S1409.

Meanwhile, if the processing state flag does not indicate “RETRYING” (step S1406: NO), the CPU 101 changes the processing state flag of the monitored sensor to “EXECUTING” (step S1408) and transitions to step S1409.

Subsequent to the operation at step S1407 or step S1408, the CPU 101 determines whether the change is successful (step S1409). If the change has failed (step S1409: NO), the CPU 101 returns to the operation at step S1406. If the change is successful (step S1409: YES), the CPU 101 acquires data from the monitored sensor (step S1410). Next, the CPU 101 sets the data state flag of the monitored sensor to “EMPTY” (step S1411), executes the processing for the sensor 103 (step S1412), and transitions to step S1501.

Meanwhile, at step S1403, if the change has failed (step S1403: NO), the CPU 101 changes the monitored sensor to the next sensor 103 (step S1413), and returns to step S1201.

Subsequent to step S1412 or in the case of “NO” at step S1507 described hereinafter, the CPU 101 acquires the processing state flag of the monitored sensor (step S1501). The CPU 101 determines whether the processing state flag of the monitored sensor indicates “EXECUTING” (step S1502). If the processing state flag of the monitored sensor does not indicate “EXECUTING” (step S1502: NO), the CPU 101 determines whether the processing state flag indicates “RETRYING&EXECUTING” (step S1503).

If the processing state flag indicates “RETRYING&EXECUTING” (step S1503: YES), the CPU 101 transitions to step S1506. On the other hand, if the processing state flag does not indicate “RETRYING&EXECUTING” (step S1503: NO), the CPU 101 changes the processing state flag of the monitored sensor to “RETRYING&FINISHED” (step S1504) and determines whether the change is successful (step S1505). If the change has failed (step S1505: NO), the CPU 101 returns to step S1501. If the change is successful (step S1505: YES), the CPU 101 transitions to step S1506.

Subsequent to “YES” at step S1503 or “YES” at step S1505, the CPU 101 acquires the data state flag of the monitored sensor (step S1506). The CPU 101 determines whether the data state flag of the monitored sensor indicates “READY” (step S1507). If the data state flag of the monitored sensor does not indicate “READY” (step S1507: NO), the CPU 101 returns to step S1501. If the data state flag of the monitored sensor indicates “READY” (step S1507: YES), the CPU 101 acquires the identification information of the CPU 101, registered in the last CPU#2 field (step S1508).

The CPU 101 sends a restart request to the CPU 101 identified by the identification information in the last CPU#2 field (step S1509). The CPU 101 stores abnormality information to the main memory (step S1510) and interrupts the MPU 104 (step S1511). The CPU 101 changes the processing state flag of the monitored sensor to “FINISHED” (step S1512) and transitions to step S1517.

Meanwhile, at step S1502, if the processing state flag of the monitored sensor indicates “EXECUTING” (step S1502: YES), the CPU 101 determines whether an abnormality has been detected (step S1513). If no abnormality has been detected (step S1513: NO), the CPU 101 transitions to step S1516. On the other hand, if an abnormality has been detected (step S1513: YES), the CPU 101 stores abnormality information to the main memory (step S1514) and interrupts the MPU 104 (step S1515). The CPU 101 changes the processing state flag of the monitored sensor to “FINISHED” (step S1516) and transitions to step S1517.

Subsequent to step S1512 or step S1516, the CPU 101 changes the monitored sensor to the next sensor 103 (step S1517) and returns to step S1201.

At step S1401, if the processing state flag of the monitored sensor does not indicate “RETRYING” (step S1401: NO), the CPU 101 transitions to step S1601. The CPU 101 determines if the processing state flag of the monitored sensor indicates any one of “RETRYING&EXECUTING” and “RETRYING&FINISHED” (step S1601). If the processing state flag of the monitored sensor indicates “RETRYING&EXECUTING” (step S1601: RET&EXE), the CPU 101 acquires the identification information registered in the last CPU#2 field (step S1602).

Next, the CPU 101 changes the processing state flag of the monitored sensor from “RETRYING&EXECUTING” to “EXECUTING” (step S1603) and determines whether the change is successful (step S1604). If the change is successful (step S1604: YES), the CPU 101 sends a restart request to the CPU 101 identified by the identification information registered in the last CPU#2 field (step S1605). The CPU 101 acquires the processing state flag of the monitored sensor (step S1606) and transitions to step S1301.

If the change has failed (step S1604: NO) or if the processing state flag of the monitored sensor indicates “RETRYING&FINISHED” (step S1601: RET&FIN), the CPU 101 transitions to step S1607. The CPU 101 changes the monitored sensor to the next sensor 103 (step S1607) and returns to step S1201.

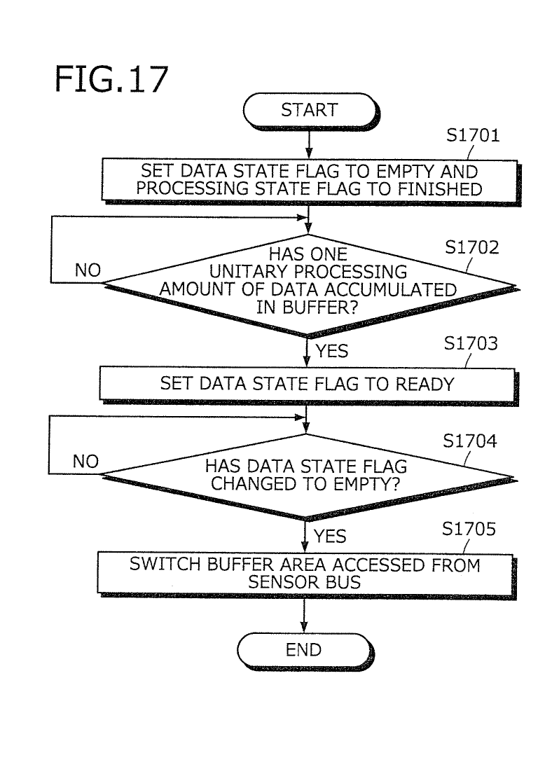

FIG. 17 is a flowchart of a processing procedure performed by the control unit 504 of the sensors 103. The control unit 504 of the sensors 103 sets the data state flag to “EMPTY” and the processing state flag to “FINISHED” when a sensor 103 is started (step S1701). Next the control unit 504 determines whether one unitary processing amount of data has accumulated in the buffer (step S1702). If one unitary processing amount of data has not accumulated in the buffer (step S1702: NO), the control unit 504 returns to step S1702.

On the other hand, if one unitary processing amount of data has accumulated in the buffer (step S1702: YES), the control unit 504 sets the data state flag to “READY” (step S1703) and determines whether the data state flag has changed to “EMPTY” (step S1704), i.e., determines whether a CPU 101 has acquired the data in the buffer.

If the data state flag has not changed to “EMPTY” (step S1704: NO), the control unit 504 returns to step S1704. On the other hand, if the data state flag has changed to “EMPTY” (step S1704: YES), the control unit 504 switches the buffer area accessed from the sensor bus 112 (step S1705), ending a series of operations.

As described, when the CPUs attempt to acquire the data generated by a sensor, the sensor is in the execution state and therefore, the CPUs acquire the data from the CPU that set the sensor to the execution state, and execute processing for the sensor. Thus, the detecting apparatus can cause the processing executed by a CPU at which a failure occurred to be re-executed by another CPU. Consequently, the detecting apparatus can cause the processing to be executed on continuous basis based on the data obtained by the sensors.

Further, a CPU that has detected that a CPU is present at which a failure has occurred releases the selection of the sensor and sets the sensor to be in the re-execution state, thereby enabling another CPU to newly select the sensor. As a result, the detecting apparatus can cause the processing executed by a down CPU to be re-executed by a given CPU and can cause another CPU to execute the processing for the sensor, based on new data. Therefore, the detecting apparatus can cause the processing for the sensors to be executed on continuous basis based on the data obtained by the sensors and can observe real-time constraints.

Further, when a given CPU re-executes the process performed by a down CPU and another CPU executes the processing for the sensor based on new data, the other CPU sets the sensor to be in the re-execution and execution state. Thus, the detecting apparatus can cause a recursively checking CPU to determine whether any one among processing executed by the down CPU and processing for a sensor based on new data is under execution. Therefore, the detecting apparatus can cause the processing for the sensors to be executed on a continuous basis based on the data obtained by the sensors and can observer real-time constraints.

Further, if the other CPU finishes executing the processing for the sensor, based in the new data, before the given CPU finishes the process executed by the down CPU, the other CPU causes the completion of the processing for the sensor based on the new data to be postponed. Thus, the detecting apparatus can observe the execution order corresponding to the order in which the data are obtained.

When re-execution of the processing executed by the CPU at which a failure occurred is completed, if the sensor is in the re-execution and execution completed state, the given CPU sets the sensor to be in the execution state. After the setting of the sensor to the re-execution and execution completed state, when the other CPU detects that the sensor has changed from the re-execution and execution completed state to the execution state, the other CPU ends the process executed by the other CPU. Thus, the detecting apparatus can observe the execution order corresponding to the order in which the data are obtained.

Further, for example, the designer of the detecting apparatus determines the CPU processing capacity and the number of CPUs according to the number of sensors and the processing performance of the sensors. Therefore, if a CPU at which a failure has occurred is left as is, the processing capacity of the CPUs may become insufficient for the processing for the sensors. Thus, after acquiring the data from the CPU at which a failure has been determined to have occurred, the given CPU sends a restart request to the CPU. As a result, the CPU at which a failure has occurred is restarted. Consequently, the detecting apparatus can cause the processing for the sensors to be executed on a continuous basis based on the data obtained by the sensors and can observe real-time constraints.

The detecting apparatus determines data to be corrupt when CPU failures successively occur consequent to processing for a sensor based on the data, and terminates execution of the process based on the data. Therefore, the detecting apparatus discards the corrupt data, thereby enabling the processing for the sensors to be executed on a continuous basis, based on the data obtained by the sensors.

The detecting method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to one aspect of the embodiments, even when a failure occurs at a CPU, processing for sensors can be continued.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A detecting apparatus comprising
a plurality of processors configured to:
access sensors;
select from among the sensors, a sensor that has not been selected by any processor, acquire data from the selected sensor, and release selection of the sensor when data acquisition has been completed;
execute processing for the sensor, based on the acquired data;
set the sensor to an execution state during execution of the processing for the sensor, and set the sensor to an execution completed state when the execution of the processing for the sensor has ended;
copy from a processor that has set the sensor to the execution state, the data acquired from the sensor by the processor, upon determining the sensor to be in the execution state, without executing the data acquisition; and
execute the processing for the sensor, based on the copied data.

2. The detecting apparatus according to claim 1, wherein
the plurality of processors further include a selection control unit that causes a processor to release the selection of the sensor without executing the data acquisition, when the sensor is determined to be in the execution state, and
the plurality of processors are configured to set the sensor to a re-execution state during the execution of the processing for the sensor, and to set the sensor to an execution completed state, when the execution the processing for the sensor, based on the copied data has ended.

3. The detecting apparatus according to claim 2, wherein
the plurality of processors are configured to determine whether the sensor is in the re-execution state while the sensor is selected, and
the plurality of processors, upon determining that the sensor is in the re-execution state, sets the sensor to a re-execution and execution state during the execution of the processing for the sensor, based on the acquired data.

4. The detecting apparatus according to claim 3, wherein
the plurality of processors further include an execution control unit that controls completion of the execution of the processing for the sensor, based on the acquired data,
the plurality of processors are configured to determine whether the sensor is in the re-execution and execution state, when execution results are obtained of the processing for the sensor, based on the acquired data,
the execution control unit refrains from ending the execution of the processing for the sensor, based on the copied data, when the sensor has been determined to be in the re-execution and execution state,
the plurality of processors is configured to set the sensor to a re-execution and execution completed state, upon determining that the sensor is in the re-execution and execution state.

5. The detecting apparatus according to claim 4, wherein
the plurality of processors are configured to determine upon completing the execution of the processing for the sensor, based on the copied data, whether the sensor is in the re-execution and execution completed state,
the plurality of processors is configured to set the sensor to the execution state, upon determining the sensor to be in the re-execution and execution completed state.

6. The detecting apparatus according to claim 5, wherein
the plurality of processors are configured to determine whether the sensor has changed from the re-execution and execution completed state to the execution state, after setting the sensor to the re-execution and execution completed state,
the execution control unit causes the execution of the processing for the sensor, based on the acquired data to end, when the sensor has been determined to have changed from the re-execution and execution completed state to the execution state.

7. The detecting apparatus according to claim 1, wherein
the plurality of processors is configured to send a restart request to the processor, after copying of the data.

8. The detecting apparatus according to claim 3, wherein
the plurality of processors are configured to determine whether the selected sensor is in the re-execution and execution state, and
the plurality of processors is configured to set the sensor to the execution state, upon determining that the sensor is in the re-execution and execution state.

9. A detecting method comprising:
selecting from among sensors, a sensor that has not been selected by any processor, acquiring data from the selected sensor, and releasing selection of the sensor when data acquisition has been completed;
executing processing for the selected sensor, based on the data acquired during the selection;
setting the sensor to an execution state during execution of the processing for the sensor, based on the data acquired during the selection, and setting the sensor to an execution completed state when the execution of the processing for sensor, based in the data acquired during the selection, has ended;
copying from a processor that has set the sensor to the execution state, the data acquired from the sensor by the processor, upon determining the sensor to be in the execution state, without executing the data acquisition; and
executing the processing for the sensor, based on the copied data, wherein
detecting method is executed by a plurality of processors configured to access the sensors.

10. A non-transitory, computer-readable recording medium storing a detecting program that causes a plurality of processors configured to access sensors, to execute a process comprising:
selecting from among the sensors, a sensor that has not been selected by any processor, acquiring data from the selected sensor, and releasing selection of the sensor when data acquisition has been completed;
executing processing for the selected sensor, based on the data acquired during the selection;
setting the sensor to an execution state during execution of the processing for the sensor, based on the data acquired during the selection, and setting the sensor to an execution completed state when the execution of the processing for sensor, based in the data acquired during the selection, has ended;
copying from a processor that has set the sensor to the execution state, the data acquired from the sensor by the processor, upon determining the sensor to be in the execution state, without executing the data acquisition; and
executing the processing for the sensor, based on the copied data.
